(19) United States
(12) Patent Application Publication
(10) Pub. No.: US 2013/0211940 A1
(43) Pub. Date: Aug. 15, 2013

(54) Metered and Conditional Access Control

(71) Applicants: Quoc Vu, Marietta, GA (US); Troy Van Aacken, Atlanta, GA (US)

(72) Inventors: Quoc Vu, Marietta, GA (US); Troy Van Aacken, Atlanta, GA (US)

(73) Assignee: AVA TECHNOLOGY VENTURES, LLC, Atlanta, GA (US)

(21) Appl. No.: 13/371,445

(22) Filed: Feb. 12, 2012

(51) Int. Cl. G06Q 30/06; G06F 15/173

(52) U.S. Cl. 705/26.1; 709/225

(57) ABSTRACT

Various methods, systems, and apparatuses can be used to perform metered and conditional access control. In some implementations, a metered and conditional access control system can operate to approve, deny, or meter a request from a requesting user device for transactions such as, for example, approval of purchases, requests for bandwidth, access to restricted content, among many others. Once prompted, a granting user device can grant, deny, or meter directly with the requesting user device or another network element. A metered and conditional access control system can also coordinate with a metered conditional access control coordinating device to facilitate conditional access and/or metering.

### TECHNICAL FIELD

This disclosure relates to metering and conditional access control.

### BACKGROUND

Mobile applications have become more prevalent in everyday life. As applications and content increases into the realm of mobile devices, smart televisions, and other devices, the need for access control becomes increasingly necessary. For example, current systems allow a user to download and/or purchase all applications or programs if the user has proper credentials. Alternatively, if the proper credentials are not presented, the user cannot download and/or purchase any applications or programs. However, access control technologies have been overly cumbersome and complicated for user and administrators.

In addition, as content is increasingly shared among users, the need to prevent unwanted access to certain types of materials to certain users has also increased. To address this issue, many solutions have emerged to restrict content such as, for example, the V-Chip. However, V-Chip solutions and other implementations are overly cumbersome and do not afford the flexibility necessary for a parent or administrator to distinguish what program he/she wishes a child to access.

Bandwidth metering is also currently conditional, where either a user has complete access to available resources on a network or a user has no access. Although service providers such as, for example, multiple service operators (MSOs) and telecommunications companies (Telcos), currently restrict access to heavy users of bandwidth, there is limited metering capability or restriction to bandwidth in a data network. As bandwidth usage increases and networks become increasingly constrained, the need to meter usage of resources becomes increasingly important.

### BRIEF DESCRIPTION OF THE DRAWINGS

FIG. 1 is a block diagram illustrating an example network environment operable to provide metered and conditional access control.

FIG. 2 is a sequence diagram illustrating an example flow for a metered and conditional access control system operable to provide application and program purchases.

FIG. 3 is a sequence diagram illustrating an example flow for a metered and conditional access control system operable to provide metered bandwidth allowance.

FIG. 4 is a flowchart illustrating an example process to provide metered and conditional access control for program or application purchases.

FIG. 5 is a flowchart illustrating an example process to provide metered and conditional access control for metered bandwidth allowance.

FIG. 6 is a flowchart illustrating an example process to provide metered and conditional access control for viewing restricted content.

FIG. 7 is a flowchart illustrating an example process to provide granting in a metered and conditional access control system.

FIG. 8 is a component diagram of an example metered and conditional access control coordinating device.

Like reference numbers and designations in the various drawings indicate like elements.

### DETAILED DESCRIPTION

This disclosure describes various methods, systems, and apparatuses that can be used to perform metered and conditional access control. In some implementations, a metered and conditional access control system can operate to approve, deny, or meter a request from a requesting user device for transactions such as, for example, approval of purchases, requests for bandwidth, access to restricted content, among many others. Once prompted, a granting user device can grant, deny, or meter directly with the requesting user device or another network element such as, for example, a coordinating device to facilitate conditional access and/or metering. Such grants can include methods such as, for example, an acknowledgement or password, fingerprint verification, or voice verification, among many others.

Systems and methods can operate to perform a metered conditional access control system by approving or denying a request from a requesting user device for a transaction. In some implementations, the request can be an approval for the purchase of an application and/or movie. For example, if a child wants to buy a mobile application and a parent wants to verify the purchase made on his/her account, then the metered and conditional access control system can require a parent's verification prior to granting the application purchase. In other implementations, the request can be to view restricted material. For example, a parent may want to restrict access to ‘R’-rated material from their children with the ability to permit or deny certain content his/her children wish to view.

Systems and methods can also operate to perform a metered conditional access control system by metering a request from a requesting user device for a transaction or allowance. In some implementations, the request can be an approval for a monetary allowance. For example, if a parent wants to grant a certain threshold for a child to spend on applications or content, then the parent can provide an allowance, which can be set and/or modified with a grant from one or both parents. In other implementations, a user can request a bandwidth allowance from an account or another user. The bandwidth allowance response can be a grant, deny, or a provided threshold or allocation.

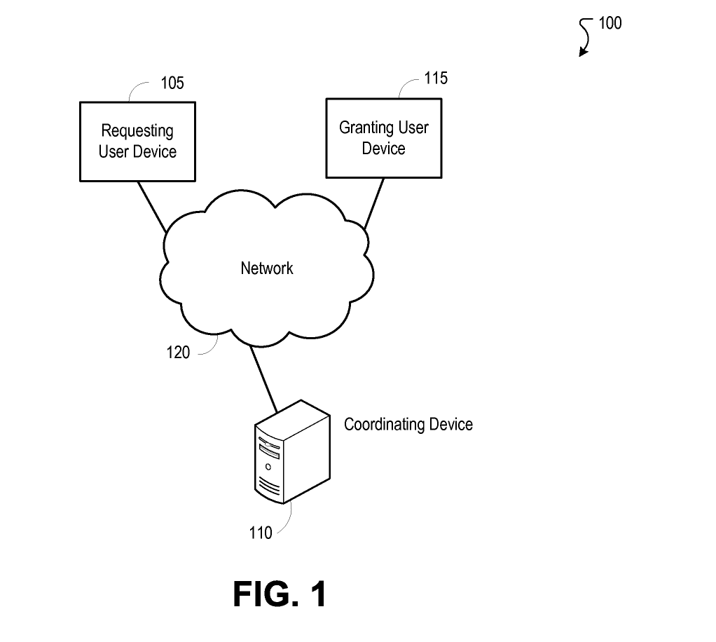

FIG. 1 is a block diagram illustrating an example network environment operable to provide metered and conditional access control. In some implementations, a metered and conditional access control system comprise interactions between a Requesting User Device 105, Coordinating Device 110, and Granting User Device 115. The devices are connected by one or multiple networks 120. In some implementations, a metered and conditional access control system can be initiated by a request for access from the Requesting User Device 105. For example, the request can be a request for approval to purchase an application or film program. In another example, the request can be a request for a bandwidth allowance.

In some implementations, a request can be transmitted from a Requesting User Device 105 to a Coordinating Device 110 and/or a Granting User Device 115. In other implementations, the Coordinating Device 110 can transmit a reformatted request to the Granting User Device 115. Once the request is received, the Granting User Device 115 can grant, deny, or set a threshold in response to the request. In some implementations, the grant can be a simple acknowledgement. In other implementations, access is granted unless the request is denied. In still further implementations, the granting user device sets a maximum or minimum threshold value. For example, a parent might set a maximum number of minutes of access to subscriber services per day for his/her child (e.g., 30 minutes per day). In another example, a parent may allow a certain number of minutes per day automatically, and require permission to grant additional minutes to his/her child.

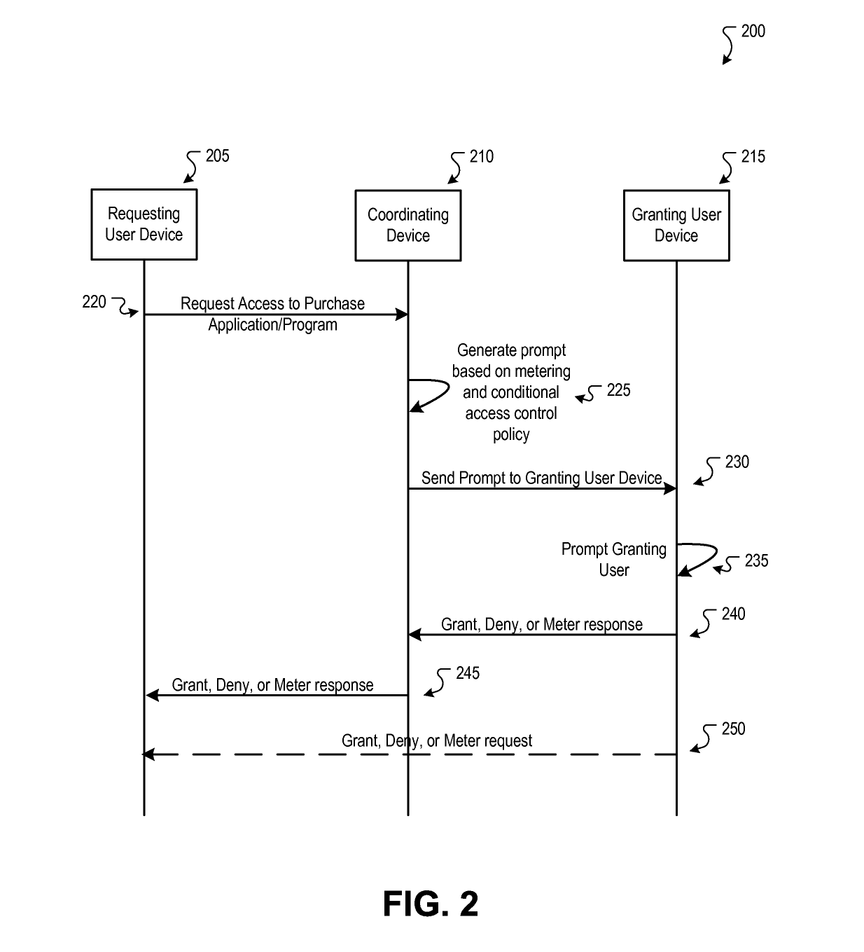

FIG. 2 is a sequence diagram illustrating an example flow for a metered and conditional access control system operable to provide application and program purchases. The sequence diagram can involve a Requesting User Device 205 (e.g., Requesting User Device 105 of FIG. 1), Coordinating Device 210 (e.g., Coordinating Device 110 of FIG. 1), and Granting User Device 215 (e.g., Granting User Device 115 of FIG. 1). The initialization flow for the metered and conditional access control system can begin when a request for access to purchase an application and/or program is detected by the Requesting User Device 205, which initiates a request to the Coordinating Device 210 (220). In some implementations, the request can be automatic. In other implementations, the Requesting User Device 205 may prompt the user prior to sending the request. In some examples, the request can be for a grant or deny of access. In other examples, the request can be for a threshold meter or allowance.

Once received, the Coordinating Device 210 can generate a prompt based on metering and conditional access control policy (225). In some implementations, the policy can be in place prior to the request. In other implementations, the policy can be transmitted with the request. In still further implementations, the policy can be received/retrieved from the Granting User Device 215 once a prompt is initiated.

Once a prompt is generated, the Coordinating Device 210 can send the prompt to the Granting User Device 215 (230). In some implementations, the prompt can be an SMS message with instructions for a reply. In other implementations, the prompt can be a request for authentication or a request to set a threshold. In still further implementations, the prompt can be sent from the Requesting User Device 205 directly to the Granting User Device 215.

Once received by the Granting User Device 215, the prompt can be processed by the granting user (235). In some implementations, the grant or denial can be a simple acknowledgement. In other implementations, the grant or denial can be setting a metered allowance. In still further implementations, the grant or denial can be a voice activated verification or another authentication method.

Once generated, the response can be sent from the Granting User Device 215 to the Coordinating Device 210 (240). In some implementations, the Coordinating Device 210 can reformat the response. In other implementations, the Coordinating Device can forward an unaltered response (245). In alternative implementations, the Granting User Device 215 can send the response directly to the Requesting User Device 205 (250).

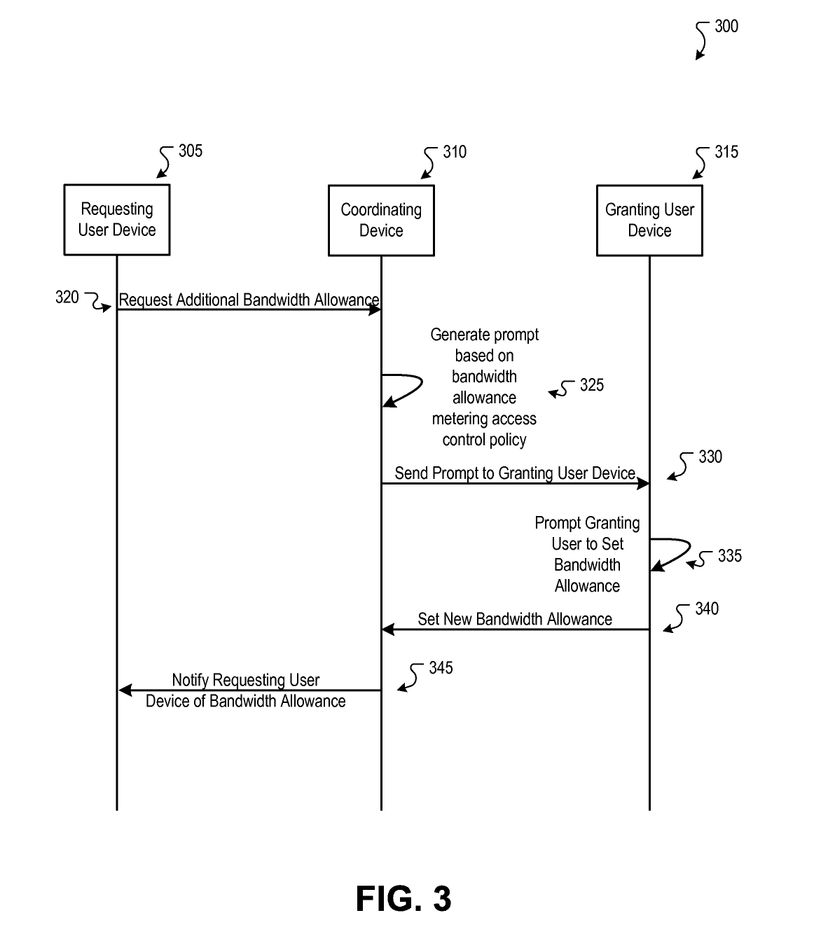

FIG. 3 is a sequence diagram illustrating an example flow for a metered and conditional access control system operable to provide metered bandwidth allowance. The sequence diagram can involve a Requesting User Device 305 (e.g., Requesting user device 105 of FIG. 1 and 205 of FIG. 2 and 305 of FIG. 3), Coordinating Device 310 (e.g., Coordinating device 110 of FIG. 1 and 210 of FIG. 2 and 310 of FIG. 3), and Granting User Device 315 (e.g., Granting user device 115 of FIG. 1 and 215 of FIG. 2 and 315 of FIG. 3). The initialization flow for the metered and conditional access control system can begin when a request for additional bandwidth is detected by the Requesting User Device 305, which initiates a request to the Coordinating Device 310 (320). In some implementations, the request can be automatic. In other implementations, the Requesting User Device 305 may prompt the user prior to sending the request. In some examples, the request can be for a grant or deny of access at a predetermined threshold. In other examples, the request can be for a requesting user defined threshold meter or allowance.

Once received, the Coordinating Device 310 can generate a prompt based on metering and conditional access control policy for an additional bandwidth allowance (325). In some implementations, the policy can be in place prior to the request. In other implementations, the policy can be transmitted with the request. In still further implementations, the policy can be received from the Granting User Device 315 once a prompt is initiated.

Once a prompt is generated, the Coordinating Device 310 can send the prompt to the Granting User Device 315 (330). In some implementations, the prompt can be an SMS message with instructions for a reply. In other implementations, the prompt can be a request for authentication or a request to set a threshold. In still further implementations, the prompt can be sent from the Requesting User Device 305 directly to the Granting User Device 315.

Once received by the Granting User Device 315, the prompt can be processed by the granting user (335). In some implementations, the grant or denial can be a simple acknowledgement granting or denying additional bandwidth. In other implementations, the grant or denial can be setting a metered bandwidth allowance. In still further implementations, the grant or denial can be a voice activated verification or another authentication method.

Once generated, the set bandwidth allowance response can be sent from the Granting User Device 315 to the Coordinating Device 310 (340). In some implementations, the Coordinating Device 310 can reformat the response and subsequently allocate the necessary bandwidth. In other implementations, the Coordinating Device 310 can forward an unaltered response (345). It should be understood that, in addition to bandwidth, the allowance can be for monetary allowance or a film/application allowance or a time allowance for a requested service (e.g., phone service). It should be understood that in various implementations, any combination of the requesting user device, coordinating device and/or granting user devices can be co-located (e.g., the same device).

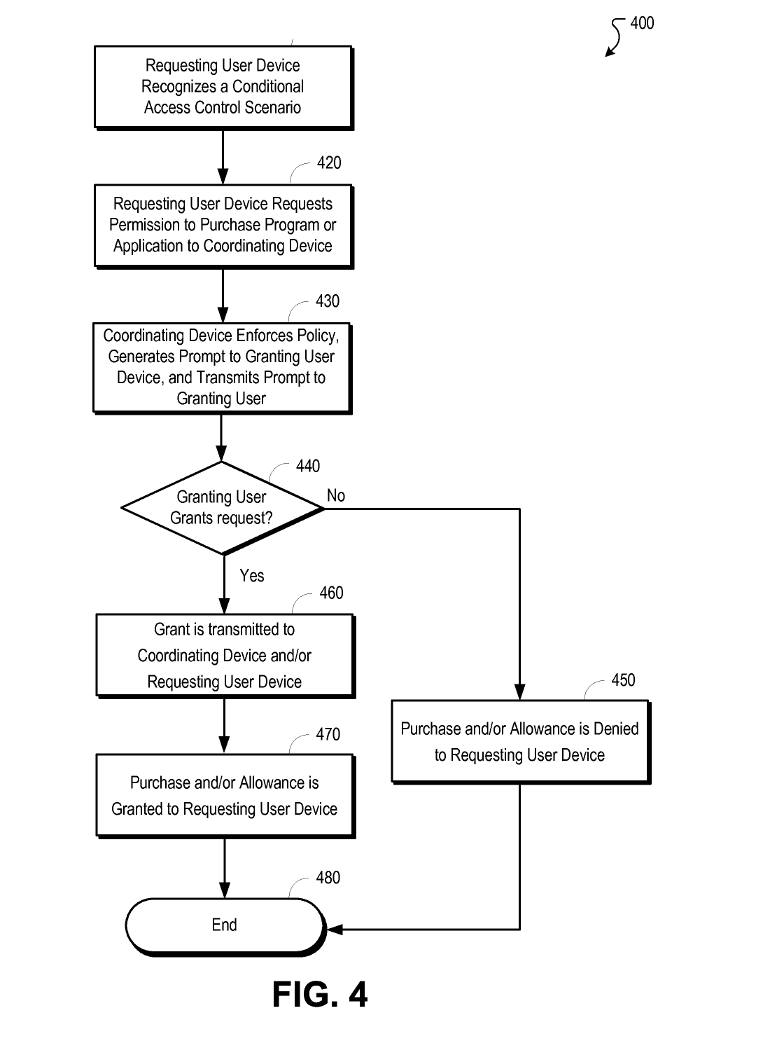

FIG. 4 is a flowchart illustrating an example process to provide metered and conditional access control for program or application purchases. This example process 400 begins at stage 410, when a requesting user device recognizes a conditional access control scenario. In some implementations, the recognition can occur at the requesting user device (e.g., requesting user device 105 of FIG. 1 and 205 of FIG. 2 and 305 of FIG. 3) and prompted by the user or device. For example, the recognition can occur when a cellular phone with advanced capabilities (e.g., a smartphone) alerts the user of a cell phone when a purchase is being made or a film program is being purchased. In other implementations, the request for access control can be prompted by an external device to the user device such as, for example, a coordinating device (e.g., coordinating device 110 of FIG. 1 and 210 of FIG. 2 and 310 of FIG. 3) or another external network element.

At stage 420, the requesting user device requests permission to purchase the program or application to the coordinating device. The request can come from the requesting user device (e.g., requesting user device 105 of FIG. 1 and 205 of FIG. 2 and 305 of FIG. 3) and can be sent to the coordinating device (e.g., coordinating device 110 of FIG. 1 and 210 of FIG. 2 and 310 of FIG. 3). In some implementations, the request can be a simple SMS message. In other implementations, the request can be another type of application specific application-programming interface (API) message. In still further implementations, the request can be implicit between the network elements.

At stage 430, the coordinating device can enforce the access control policy, generate a prompt to a granting user device, and transmit a prompt to the granting user. The enforcement policy, prompt generation, and transmission can come from the coordinating device (e.g., coordinating device 110 of FIG. 1 and 210 of FIG. 2 and 310 of FIG. 3) to the granting user device (e.g., granting user device 115 of FIG. 1 and 215 of FIG. 2 and 315 of FIG. 3). In some implementations, the policy can be an allowance and/or limit of application purchases. In other implementations, the policy can be based on application or program purchases within a given time-frame. In some implementations, the prompt can be a reformatted message to the granting user device. In other implementations, the prompt can forward the request from the requesting user device. It should be understood that the transmission can occur via numerous methods such as, for example, an SMS message, an internal program API message, control signaling, an interactive voice response system, and/or combinations thereof, among many others.

At stage 440, a determination is made whether the request is granted. The determination of whether the request is granted can be made by the granting user device (e.g., granting user device 115 of FIG. 1 and 215 of FIG. 2 and 315 of FIG. 3). In some implementations, the grant can be an affirmative action by the granting user. In other implementations, the absence of an explicit grant or denial can trigger a default response.

If the granting user does not grant the request at stage 440, then at stage 450, the purchase and/or allowance is denied to the requesting user device. In some implementations, the denial by the granting user device (e.g., granting user device 115 of FIG. 1 and 215 of FIG. 2 and 315 of FIG. 3) can occur as an explicit response to the requesting user device (e.g., requesting user device 105 of FIG. 1 and 205 of FIG. 2 and 305 of FIG. 3) and/or the coordinating device (e.g., coordinating device 110 of FIG. 1 and 210 of FIG. 2 and 310 of FIG. 3). In other implementations, the denial can be an absence of a grant. The process 400 ends at stage 480.

If the request is granted at stage 440, then at stage 460, the purchase and/or allowance is granted to the requesting user device. In some implementations, the grant by the granting user device (e.g., granting user device 115 of FIG. 1 and 215 of FIG. 2 and 315 of FIG. 3) can occur as an explicit grant response to the requesting user device (e.g., requesting user device 105 of FIG. 1 and 205 of FIG. 2 and 305 of FIG. 3) and/or the coordinating device (e.g., coordinating device 110 of FIG. 1 and 210 of FIG. 2 and 310 of FIG. 3). In other implementations, the grant can occur automatically after a given timeout.

At stage 470, the purchase and/or allowance is granted and the application or program is provided to the requesting user device. In some implementations, the provided program and/or allowance can be provided by the coordinating device (e.g., coordinating device 110 of FIG. 1 and 210 of FIG. 2 and 310 of FIG. 3) or other networked device. In other implementations, authentication credentials can be provided to the requesting user device (e.g., requesting user device 105 of FIG. 1 and 205 of FIG. 2 and 305 of FIG. 3) to grant access. The process 400 ends at stage 480.

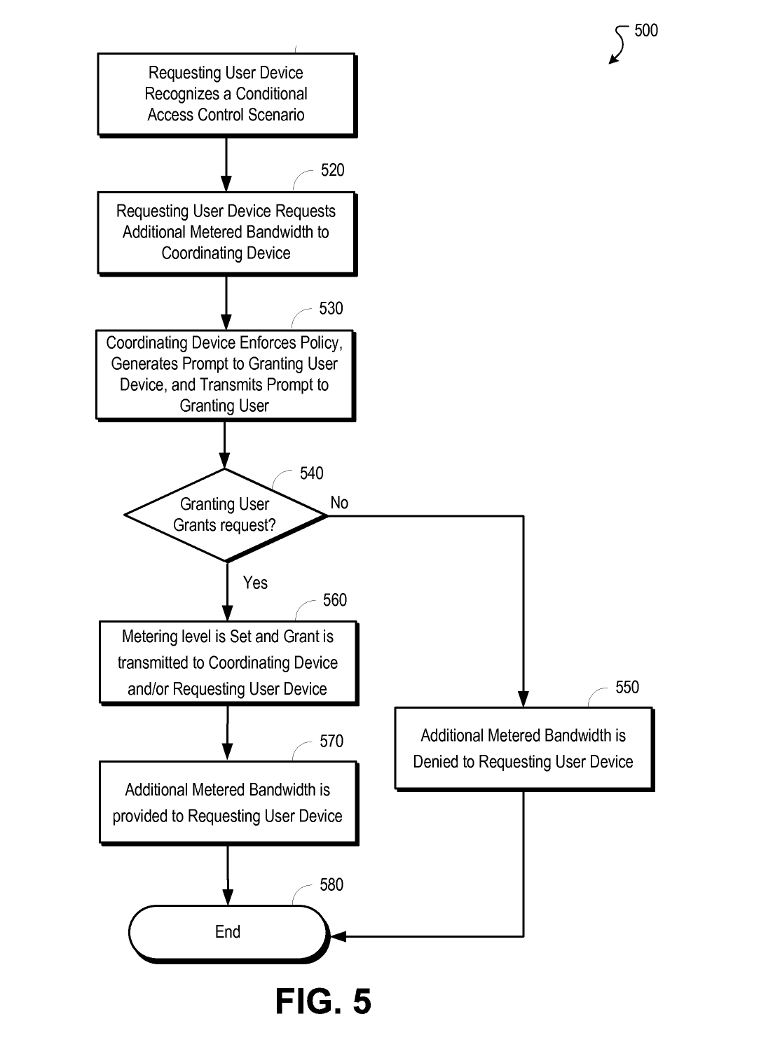

FIG. 5 is a flowchart illustrating an example process to provide metered and conditional access control for metered bandwidth allowance. This example process 500 begins at stage 510, when a requesting user device recognizes a conditional access control scenario. In some implementations, the recognition can occur at the requesting user device (e.g., requesting user device 105 of FIG. 1 and 205 of FIG. 2 and 305 of FIG. 3) and prompted by the user or device. For example, the recognition can occur when a user desires additional bandwidth allocation. In other implementations, the request for access control can be prompted by an external device to the user device such as, for example, a coordinating device (e.g., coordinating device 110 of FIG. 1 and 210 of FIG. 2 and 310 of FIG. 3) or another external network element.

At stage 520, the requesting user device sends a request for additional metered bandwidth to the coordinating device. The request can come from the requesting user device (e.g., requesting user device 105 of FIG. 1 and 205 of FIG. 2 and 305 of FIG. 3) and can be sent to the coordinating device (e.g., coordinating device 110 of FIG. 1 and 210 of FIG. 2 and 310 of FIG. 3). In some implementations, the request can be a simple SMS message. In other implementations, the request can be another type of application specific API message. In still further implementations, the request can be implicit between the network elements.

At stage 530, the coordinating device can enforce the access control policy, generate a prompt to a granting user device, and transmit a prompt to the granting user. The enforcement policy, prompt generation, and transmission can come from the coordinating device (e.g., coordinating device 110 of FIG. 1 and 210 of FIG. 2 and 310 of FIG. 3) to the granting user device (e.g., granting user device 115 of FIG. 1 and 215 of FIG. 2 and 315 of FIG. 3). In some implementations, the policy can be an allowance and/or limit of metered bandwidth. In other implementations, the policy can be based on bandwidth usage within a given time-frame. In some implementations, the prompt can be a reformatted message to the granting user device. In other implementations, the prompt can forward the request from the requesting user device. It should be understood that the transmission can occur via numerous methods such as, for example, an SMS message, an internal program API message, control signaling, an interactive voice response system, and/or combinations thereof, among many others.

At stage 540, a determination is made whether the request is granted. The grant determination can be made by the granting user device (e.g., granting user device 115 of FIG. 1 and 215 of FIG. 2 and 315 of FIG. 3). In some implementations, the grant can be an affirmative action by the granting user. In other implementations, the absence of an explicit grant or denial can trigger a default response.

If the request is not granted at stage 540, then at stage 550, the additional metered bandwidth is denied to the requesting user device. In some implementations, the denial by the granting user device (e.g., granting user device 115 of FIG. 1 and 215 of FIG. 2 and 315 of FIG. 3) can occur as an explicit response to the requesting user device (e.g., requesting user device 105 of FIG. 1 and 205 of FIG. 2 and 305 of FIG. 3) and/or the coordinating device (e.g., coordinating device 110 of FIG. 1 and 210 of FIG. 2 and 310 of FIG. 3). In other implementations, the denial can be an absence of a grant. The process 500 ends at stage 580.

If the granting user does grant the request at stage 540, then at stage 560, the metered bandwidth level is set and the grant is transmitted to the coordinating device and/or the requesting user device. In some implementations, the grant by the granting user device (e.g., granting user device 115 of FIG. 1 and 215 of FIG. 2 and 315 of FIG. 3) can occur as an explicit grant response to the requesting user device (e.g., requesting user device 105 of FIG. 1 and 205 of FIG. 2 and 305 of FIG. 3) and/or the coordinating device (e.g., coordinating device 110 of FIG. 1 and 210 of FIG. 2 and 310 of FIG. 3). In other implementations, the grant can occur automatically after a given timeout.

At stage 570, the additional metered bandwidth is provided to the requesting user device. In some implementations, the metered bandwidth and/or allowance can be provided by the coordinating device (e.g., coordinating device 110 of FIG. 1 and 210 of FIG. 2 and 310 of FIG. 3) or other networked device. In other implementations, authentication credentials can be provided to the requesting user device (e.g., requesting user device 105 of FIG. 1 and 205 of FIG. 2 and 305 of FIG. 3) to grant additional bandwidth. The process 500 ends at stage 580.

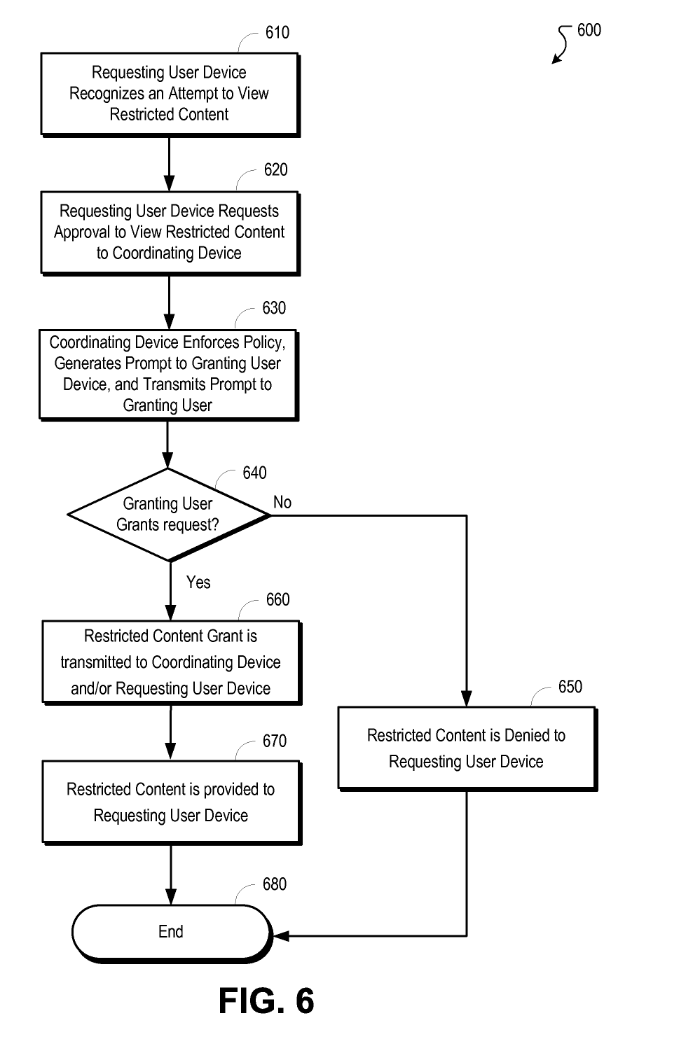

FIG. 6 is a flowchart illustrating an example process to provide metered and conditional access control for viewing restricted content. This example process 600 begins at stage 610, when a requesting user device recognizes a conditional access control scenario for restricted material. In some implementations, the recognition can occur at the requesting user device (e.g., requesting user device 105 of FIG. 1 and 205 of FIG. 2 and 305 of FIG. 3) and prompted by the user or device. For example, the recognition can occur when a minor is trying to download and/or view a restricted film program such as, for example, an ‘R’-rated movie (e.g., as rated by the Motion Picture Association of America (MPAA) of Washington, D.C.) that requires granting of consent from a parent. In other implementations, the request for access control can be prompted by an external device to the user device such as, for example, a coordinating device (e.g., coordinating device 110 of FIG. 1 and 210 of FIG. 2 and 310 of FIG. 3) or another external network element.

At stage 620, the requesting user device sends a request for permission to view restricted material to the coordinating device. The request can come from the requesting user device (e.g., requesting user device 105 of FIG. 1 and 205 of FIG. 2 and 305 of FIG. 3) and can be sent to the coordinating device (e.g., coordinating device 110 of FIG. 1 and 210 of FIG. 2 and 310 of FIG. 3). In some implementations, the request can be a simple SMS message. In other implementations, the request can be another type of application specific API message. In still further implementations, the request can be implicit between the network elements.

At stage 630, the coordinating device can enforce the access control policy, generate a prompt to a granting user device, and transmit a prompt to the granting user. The enforcement policy, prompt generation, and transmission can come from the coordinating device (e.g., coordinating device 110 of FIG. 1 and 210 of FIG. 2 and 310 of FIG. 3) to the granting user device (e.g., granting user device 115 of FIG. 1 and 215 of FIG. 2 and 315 of FIG. 3). In some implementations, the policy can be restricting a certain type of content such as, for example, an ‘R’-rated movie. In other implementations, the policy can be based on programs from a specific source or website. In some implementations, the prompt can be a reformatted message to the granting user device. In other implementations, the prompt can forward the request from the requesting user device. It should be understood that the transmission can occur via numerous methods such as, for example, an SMS message, an internal program API message, among many others.

At stage 640, a determination is made whether the granting user grants the request. The determination can be made by the granting user device (e.g., granting user device 115 of FIG. 1 and 215 of FIG. 2 and 315 of FIG. 3). In some implementations, the grant can be an affirmative action by the granting user. In other implementations, the absence of an explicit grant or denial can trigger a default response.

If the granting user does not grant the request at stage 640, then at stage 650, the content is denied to the requesting user device. In some implementations, the denial by the granting user device (e.g., granting user device 115 of FIG. 1 and 215 of FIG. 2 and 315 of FIG. 3) can occur as an explicit response to the requesting user device (e.g., requesting user device 105 of FIG. 1 and 205 of FIG. 2 and 305 of FIG. 3) and/or the coordinating device (e.g., coordinating device 110 of FIG. 1 and 210 of FIG. 2 and 310 of FIG. 3). In other implementations, the denial can be an absence of a grant. The process 600 ends at stage 680.

If the granting user does grant the request at stage 640, then at stage 660, the content is granted to the requesting user device. In some implementations, the grant by the granting user device (e.g., granting user device 115 of FIG. 1 and 215 of FIG. 2 and 315 of FIG. 3) can occur as an explicit grant response to the requesting user device (e.g., requesting user device 105 of FIG. 1 and 205 of FIG. 2 and 305 of FIG. 3) and/or the coordinating device (e.g., coordinating device 110 of FIG. 1 and 210 of FIG. 2 and 310 of FIG. 3). In other implementations, the grant can occur automatically after a given timeout.

At stage 670, the content is provided to the requesting user device. In some implementations, the content can be provided by the coordinating device (e.g., coordinating device 110 of FIG. 1 and 210 of FIG. 2 and 310 of FIG. 3) or other networked device. In other implementations, authentication credentials can be provided to the requesting user device to grant access. The process 600 ends at stage 680.

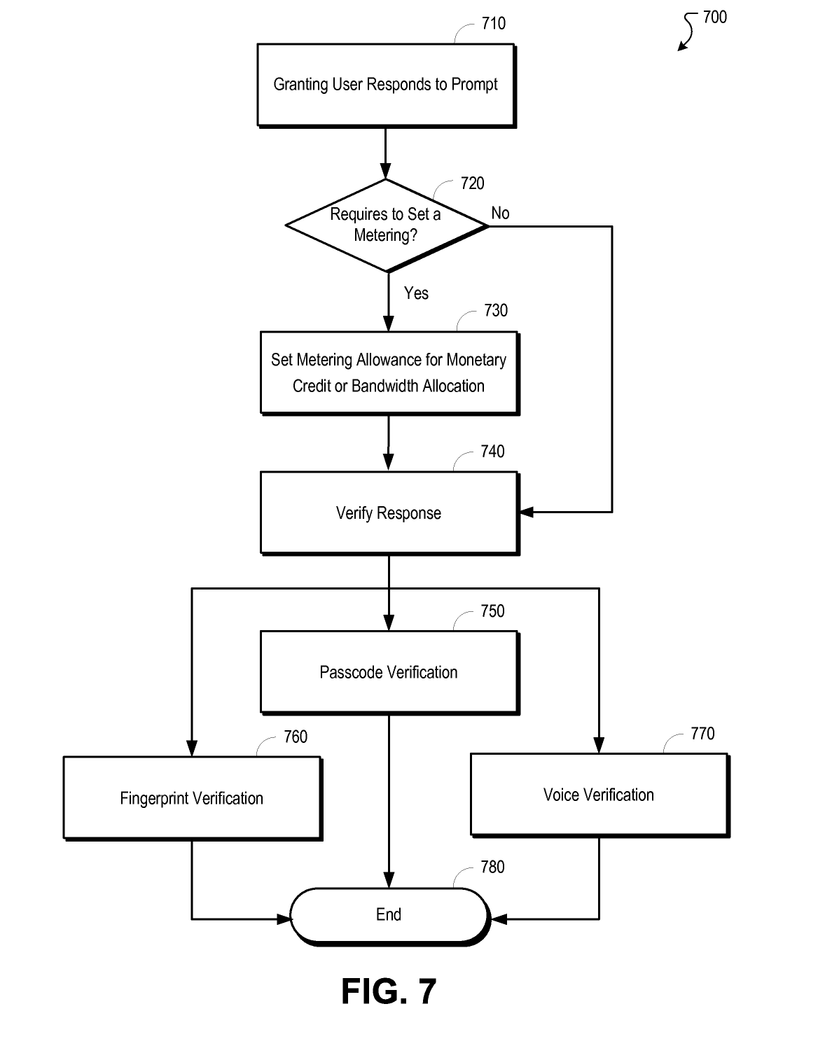

FIG. 7 is a flowchart illustrating an example process to provide granting in a metered and conditional access control system. This example process 700 begins at stage 710, when a granting user responds to a prompt. The prompt can be sent from a requesting user device (e.g., requesting user device 105 of FIG. 1 and 205 of FIG. 2 and 305 of FIG. 3) and/or coordinating device (e.g., coordinating device 110 of FIG. 1 and 210 of FIG. 2 and 310 of FIG. 3) to the granting user device (e.g., granting user device 115 of FIG. 1 and 215 of FIG. 2 and 315 of FIG. 3). In some implementations, the grant can be in response to a request to purchase an application or a program. In other implementations, the grant can be in a response to a request for additional bandwidth. In still further implementations, the grant can be in response to a request to view restricted content.

At stage 720, a determination is made whether the grant requires setting a level for metering or allowance. The determination can be made by the granting user device (e.g., granting user device 115 of FIG. 1 and 215 of FIG. 2 and 315 of FIG. 3) and/or coordinating device (e.g., coordinating device 110 of FIG. 1 and 210 of FIG. 2 and 310 of FIG. 3). In some implementations, the setting of the metered level can be explicit. In other implementations, the setting of the metered level can be implicit in the request.

If the grant requires setting a level at stage 720, then at stage 730, the meter is set. The meter and/or allowance can be set by the granting user device (e.g., granting user device 115 of FIG. 1 and 215 of FIG. 2 and 315 of FIG. 3) and/or the coordinating device (e.g., coordinating device 110 of FIG. 1 and 210 of FIG. 2 and 310 of FIG. 3). In some implementations, set metering is a monetary allowance or limit. In other implementations, the set metering is a bandwidth allowance or limit. The process proceeds to stage 740 where the grant response is verified.

If the grant does not require setting a level at stage 720, then at stage 740, the grant response is verified. The grant response is verified by the granting user device (e.g., granting user device 115 of FIG. 1 and 215 of FIG. 2 and 315 of FIG. 3). In some implementations, the grant response requires an affirmative response. In alternative implementations, the grant response can occur with an absence of an explicit denial. It should be understood that verification can include the following methods, among many others.

At stage 750, an example verification method can be a passcode verification. The passcode verification can be performed by the granting user device (e.g., granting user device 115 of FIG. 1 and 215 of FIG. 2 and 315 of FIG. 3) using the granting user's passcode. For example, the granting device can be a smart cellular phone that allows passcode entry for verification. The process 700 ends at stage 780.

At stage 760, another example verification method can be a fingerprint verification. The fingerprint verification can be performed by the granting user device (e.g., granting user device 115 of FIG. 1 and 215 of FIG. 2 and 315 of FIG. 3) using the granting user's fingerprint. For example, the granting device can be a smart cellular phone that reads fingerprints for verification. The process 700 ends at stage 780.

At stage 770, another example verification method can be a voice verification. The voice verification can be performed by the granting user device (e.g., granting user device 115 of FIG. 1 and 215 of FIG. 2 and 315 of FIG. 3) using the granting user's voice. For example, the granting device can be a smart cellular phone that interprets voice for verification. The process 700 ends at stage 780.

It should be understood that in addition to bandwidth, content, service, etc., the metered and conditional access control systems described herein can apply to the operating system of the requesting user device and or applications provided by the requesting user device. Thus, for example, a first user (e.g., a parent) can provide permission for a second user (e.g., a child) to access the device itself, or limit the applications that the second user can access on the device (e.g., by hiding devices that are unavailable to the second user or by refusing instantiation of such applications). It should also be appreciated that in further extensions of this architecture, a first user can provide access to his/her device settings and applications to a remote second user via the requesting user device. In such applications, the applications/services would be located “in the cloud” and provided to the requesting device responsive to authentication from the granting user device.

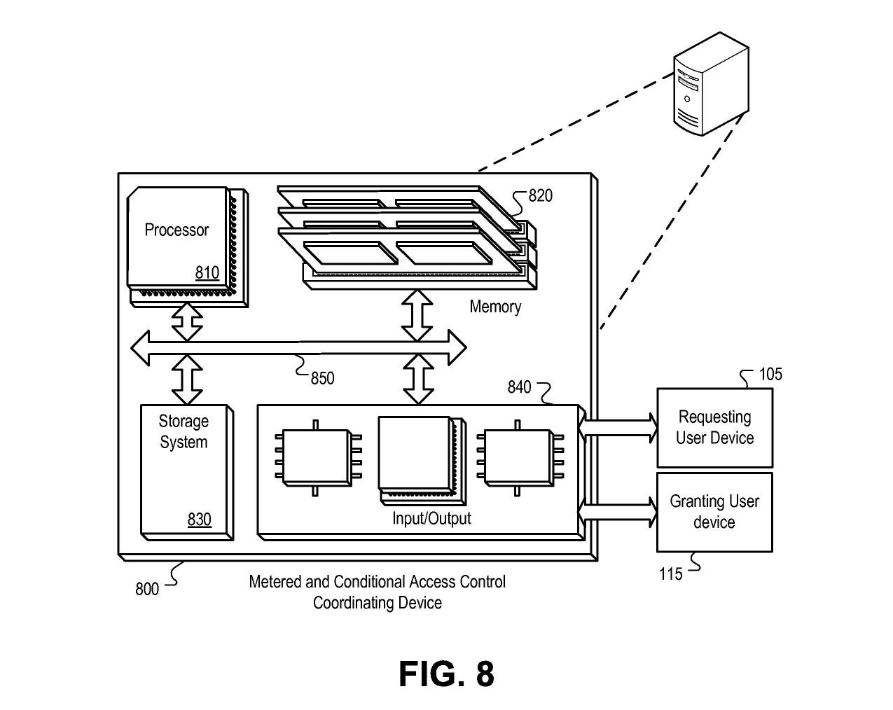

FIG. 8 is a component diagram of an example metered and conditional access control coordinating device. The metered and conditional access control coordinating device 800 can include a processor 810, a memory 820, a storage device 830, and an input/output device 840. Each of the components 810, 820, 830, and 840 can be interconnected, for example, using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830.

The memory 820 stores information within the device 800. In one implementation, the memory 820 is a computer-readable medium. In one implementation, the memory 820 is a volatile memory unit. In another implementation, the memory 820 is a non-volatile memory unit.

In some implementations, the storage device 830 is capable of providing mass storage for the device 800. In one implementation, the storage device 830 is a computer-readable medium. In various different implementations, the storage device 830 can include, for example, a hard disk device, an optical disk device, flash memory or some other large capacity storage device.

The input/output device 840 provides input/output operations for the device 800. In one implementation, the input/output device 840 can interface to a Requesting User Device 105 or a Granting User Device 115. In addition, such input/output device 840 can communicate with other external devices through various interfaces such as, for example, an IP network interface device, e.g., an Ethernet card, a cellular network interface, a serial communication device, e.g., and RS-232 port, and/or a wireless interface device, e.g., and 802.11 card. In another implementation, the input/output device can include driver devices configured to receive input data and send output data to other input/output devices (e.g., a Requesting User Device 105 and/or Granting User Device 115), as well as sending communications to, and receiving communications from various networks (not shown).

The device of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

The term “system processor” encompasses all apparatus, devices, and machines for processing data, including by way of example a programmable processor, a digital signal processor, a computer, or multiple processors or computers. The system processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The elements of a computer typically include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile communications device, a telephone, a cable modem, a set-top box, a mobile audio or video player, or a game console, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be operable to interface with a computing device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

What is claimed is:

1. A metered and conditional access control requesting user device, comprising:
a processor module operable to recognize a conditional access control scenario and generate a conditional access request;
a interface module operable to transmit a signal comprising a conditional access request;
wherein the interface is further operable to receive a conditional access control response;
wherein the processor module is further operable to process the conditional access control response;
wherein the conditional access request contains a current user information; and
wherein the conditional access request contains a current account association.

2. The metered and conditional access control requesting user device of claim 1, wherein the conditional access control response is received from a granting user device.

3. The metered and conditional access control requesting user device of claim 1, wherein the conditional access control response is received from a coordinating device.

4. The metered and conditional access control requesting user device of claim 1, wherein the conditional access control response is a metered monetary allowance limit in response to a purchase request.

5. The metered and conditional access control requesting user device of claim 1, wherein the conditional access control response is a metered allowance limit in response to a bandwidth usage request.

6. The metered and conditional access control requesting user device of claim 1, wherein the conditional access control response is a grant or deny of a restricted content request.

7. The metered and conditional access control requesting user device of claim 1, wherein the conditional access control response is a grant or deny of a purchase request.

8. The metered and conditional access control requesting user device of claim 1, wherein the conditional access control response is a grant or deny of a bandwidth usage request.

9. The metered and conditional access control requesting user device of claim 1, wherein the metered and conditional access control requesting user device is a multi-functional cellular telephone.

10. A metered and conditional access control coordinating device, comprising:
an interface operable to receive a signal comprising a conditional access request;
a processor module operable to process the conditional access request;
wherein the processor module further operable to generate a prompt for a conditional access control response;
wherein the interface is further operable to transmit the prompt to a granting user device; and
wherein the processor module is further operable to process the conditional access control response.

11. The metered and conditional access control coordinating device of claim 10, wherein the conditional access control response is received from a granting user device.

12. The metered and conditional access control requesting user device of claim 10, wherein the conditional access control response is a metered monetary allowance limit in response to a purchase request.

13. The metered and conditional access control requesting user device of claim 10, wherein the conditional access control response is a metered allowance limit in response to a bandwidth usage request.

14. The metered and conditional access control requesting user device of claim 10, wherein the conditional access control response is a grant or deny of a restricted content request.

15. The metered and conditional access control requesting user device of claim 10, wherein the conditional access control response is a grant or deny of a purchase request.

16. The metered and conditional access control requesting user device of claim 10, wherein the conditional access control response is a grant or deny of a bandwidth usage request.

17. A computer implemented method comprising:
recognizing a metered and conditional access control scenario;
generating a conditional access control request via a requesting user device processor;
transmitting the conditional access control request via a requesting user device interface;
coordinating the conditional access control request via a conditional access control coordinating device;
generating a conditional access control response via a granting user device interface; and
transmitting the conditional access control response via the granting user device interface.

18. The computer implemented method of claim 17, wherein the conditional access control response is a metered monetary allowance limit in response to a purchase request.

19. The computer implemented method of claim 17, wherein the conditional access control response is a metered allowance limit in response to a bandwidth usage request.

20. The computer implemented method of claim 17, wherein the conditional access control response is a grant or deny of a restricted content request.
